(19) United States
(12) Patent Application Publication
(10) Pub. No.: US 2026/0241606 A1
(43) Pub. Date: Aug. 20, 2026

(54) GRINDING SEGMENT FOR CHAINSAW CHAIN

(71) Applicant: Oregon Tool, Inc., Portland, OR (US)

(72) Inventors: Isaac Safdie-Miller, Portland, OR (US); Edgar A. Dallas, Portland, OR (US); Antony Nguyen, Portland, OR (US)

(73) Assignee: Oregon Tool, Inc., Portland, OR (US)

(21) Appl. No.: 19/538,532

(22) Filed: Feb. 12, 2026

Related U.S. Application Data
(60) Provisional application No. 63/782,769, filed on Apr. 3, 2025.
(60) Provisional application No. 63/758,928, filed on Feb. 14, 2025.

(51) Int. Cl. B27B 17/00; B27B 33/14

(52) U.S. Cl. CPC B27B 17/0016; B27B 33/144

(57) ABSTRACT

A saw chain includes a tie strap or drive link and a grinding segment coupled to the tie strap or the drive link. The grinding segment includes a base material, diamond particles, graphite particles, and metal coating. The diamond particles are distributed within the base material and bonded to or captured within the base material. The graphite particles are distributed within the base material. The metal coating encapsulates the graphite particles and is bonded to the base material.

### CROSS-REFERENCE TO RELATED PATENT APPLICATIONS

This application claims the benefit of and priority to U.S. Provisional Patent Application 63/758,928, filed on February 14, 2025 and U.S. Provisional Patent Application 63/782,769, filed on April 3, 2025, each of which is incorporated herein by reference in its entirety.

### BACKGROUND

The present disclosure relates generally to chainsaws, in particular to saw chains for use with concrete and aggregate-grinding chains. Contoured grinding segments included in such saw chains can include abrasive grinding particles such as diamond particles distributed within a 3-dimensional matrix. A typical matrix used for supporting the abrasive grinding particles used for concrete grinding is composed of hard, abrasive-resistant, metal material. For the abrasive grinding particles such as diamonds provided in the matrix to effectively grind the concrete, one challenge is causing the points of the diamond particles within the matrix surface level to be efficiently exposed during initial grinding as the matrix material is ground off (referred to in the art as “self-dressing”). Another challenge is providing durability of the grinding segments (e.g., to prolong useful life of the segments) while also allowing exposure of the diamond particles to enable grinding, abrasion, etc. of the concrete or other material.

### SUMMARY

At least one embodiment relates to a saw chain. The saw chain includes a tie strap or drive link and a grinding segment. The grinding segment is coupled to the tie strap or the drive link. The grinding segment includes a base material, diamond particles, graphite particles, and metal coating. The diamond particles are distributed within the base material and bonded to or captured within the base material. The graphite particles are distributed within the base material. The metal coating encapsulates the graphite particles and is bonded to the base material.

Another embodiment relates to a grinding segment for a saw chain. The grinding segment includes a base material, diamond particles, and graphite particles. The diamond particles are distributed within the base material and bonded to or captured within the base material. The graphite particles are distributed within the base material. The metal coating encapsulates the graphite particles and is bonded to the base material.

Yet another embodiment relates to a chainsaw configured to grind concrete. The chainsaw includes a saw chain. The saw chain includes a tie strap or drive link and a grinding segment coupled to the tie strap or the drive link. The grinding segment includes a base material, diamond particles, graphite particles, and metal coating. The diamond particles are distributed within the base material and bonded to or captured within the base material. The graphite particles are distributed within the base material. The metal coating encapsulates the graphite particles and is bonded to the base material.

This summary is illustrative only and is not intended to be in any way limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a chainsaw having a saw chain with grinding segments, according to some embodiments;

FIG. 2 is a perspective view of a portion of the saw chain of FIG. 1, according to some embodiments;

FIG. 3 is a side view of one of the grinding segments of the saw chain FIG. 2 including a base section and a grinding section, according to some embodiments;

FIG. 4 is a side view of the grinding section of FIG. 3, according to some embodiments; and

FIG. 5 is a block diagram of the grinding segment of FIG. 3, according to some embodiments.

### DETAILED DESCRIPTION

Referring generally to the figures, views of a concrete-cutting chainsaw, a saw chain for cutting concrete and other aggregate materials (e.g., by grinding through such concrete and/or other material), and contoured grinding segments of the saw chain are shown, according to various embodiments. As described in further detail below, the teachings herein relate to a grinding segment which includes diamond particles and metal-coated graphite particles distributed within a base material. The graphite particles improve utilization rate of the diamond particles by enhancing the rate of self–sharpening, promoting continual diamond exposure, creating slurry cavities, and forming graphite lubrication film between the grinding segment and a work piece while reducing hot corrosion of the diamond particles (e.g., degradation of diamond particles when subject to elevated temperatures) in the grinding segment. The metal coating enables the graphite particles to bind to the base material, decreasing the amount of operator effort used during grinding and enabling the speed of the cut to increase without significantly decreasing the life of the saw chain. Additionally, the coating facilities manufacturing processes as the coated graphite behaves more favorably relative to raw graphite in the mixture used to form grinding segments.

Prior to the innovations herein, those in the art would have considered that adding graphite to saw chains would reduce the useful life of the saw chain. For example, graphite does not bond well in the diamond segment matrix, resulting in diametral pores and cracks in the metal matrix. The pores and cracks reduce the strength, performance, and lifespan of the saw chain. In sharpened cutting tools such as blades for circular saws (sharpened to shear or slide, rather than grind as for the saw chain segments herein), graphite may be used in some scenarios; however, the addition of graphite particles would be considered as reducing the life span of the circular saw blade, in a manner that would have been expected to be amplified if used in a grinding tool such as the saw chain herein. The composition of such sharpened cutting tools is generally not expected in the art to be readily translated to use in grinding segments for saw chain as contemplated by the present disclosure. Advantageously, an aspect of the present disclosure is a determination that the saw chain described herein achieves an unexpected result of improving grinding performance of an abrading or grinding saw chain without compromising the durability and life of the saw chain.

These and other advantages are provided by the teachings herein, which can be implanted as part of cutting segments as described in U.S. Application No. 18/906,058, the entire disclosure of which is incorporated by reference herein.

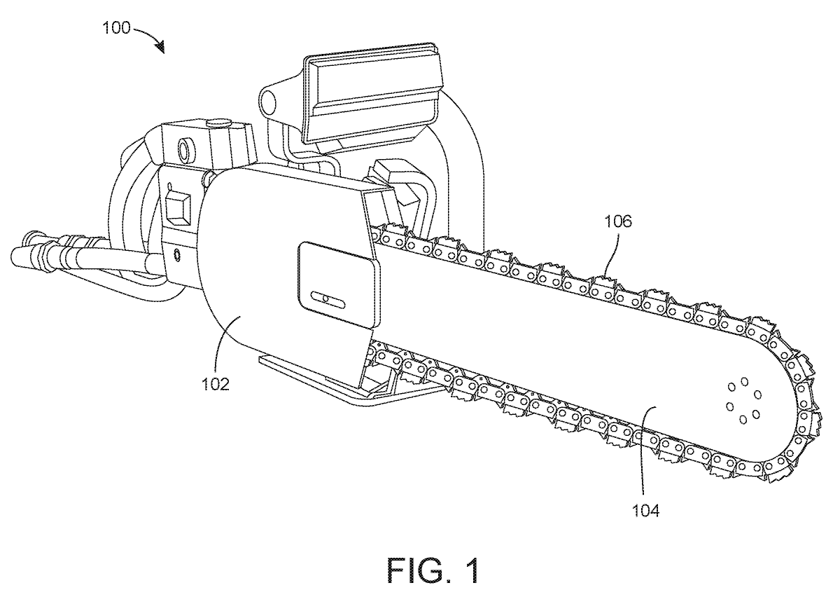

Referring now to FIG. 1, a chainsaw 100 is shown, according to some embodiments. The chainsaw 100 as shown in FIG. 1 is configured for cutting concrete and other similar materials (e.g., asphalt, aggregate, etc.). The chainsaw 100 includes a body 102, a guide bar 104 coupled and extending from the body 102, and a saw chain 106 coupled to the guide bar 104 and extending along a periphery of the guide bar 104 (e.g., in a closed loop). The body 102 includes a motor (e.g., combustion engine, electric motor) operable to rotate the saw chain 106 around the periphery of the guide bar 104, such that the saw chain 106 rotates around the guide bar 104 during operation of the chainsaw 100. The saw chain 106 includes contoured grinding segments or links with sharp or rough portions, etc. (e.g., as described in detail below) such that, when driven to rotate around the guide bar 104, the saw chain 106 can cut into, grind, etc. external objects, materials etc. The chainsaw 100 can also include irrigation features for lubricating and cooling the chain and otherwise facilitating high-power cutting and grinding operations of the chainsaw 100.

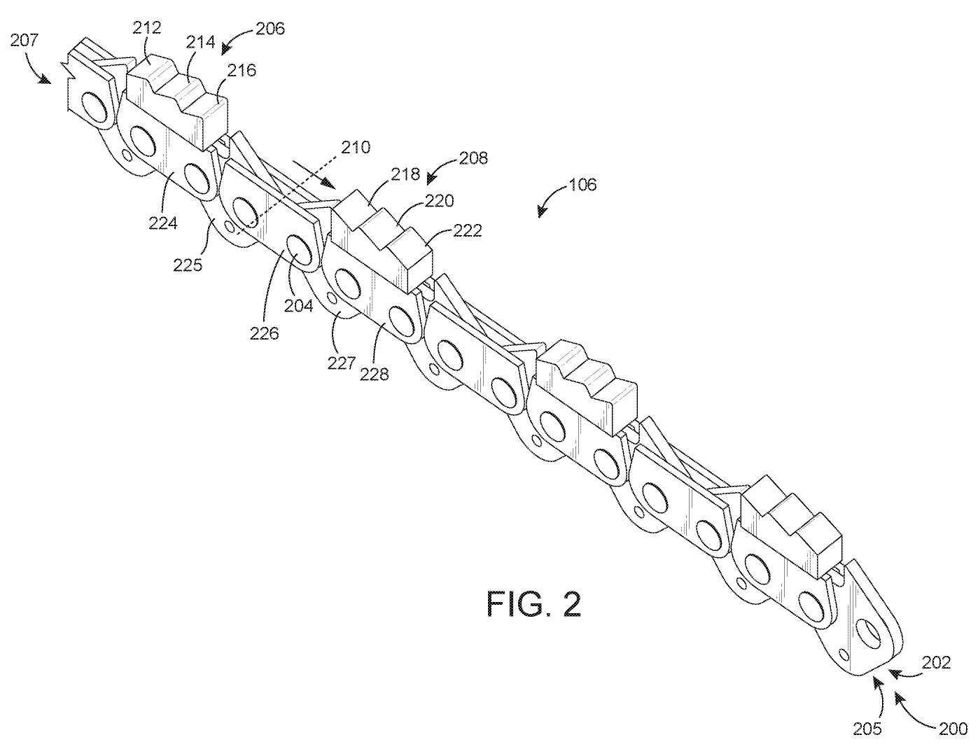

Referring now to FIG. 2, a perspective view of the saw chain 106 is shown, according to some embodiments. The saw chain 106 is configured to cut concrete and aggregate when used with the chainsaw 100. The saw chain 106 comprises drive links 200 coupled to tie straps 202 by rivets 204. The drive links 200 include extensions 207 from the saw chain 106 configured to slot into a groove provided on the periphery of the guide bar 104. Drive links 200 couple the saw chain 106 to this guide bar 104 and provide an interface between a motor, etc., of the chainsaw 100 and the saw chain 106 to enable the saw chain 106 to be driven around the guide bar 104 during operation of the chainsaw 100. The drive links 200 are coupled to one another by tie straps 202 positioned on both lateral sides of the drive links 200. The tie straps 202 couple the drive links together 200 so that the saw chain 106 can be assembled into a loop. The drive links 200 and tie straps 202 are coupled by rivets 204 which act as a coupler for the different portions of the saw chain 106. As shown in the disclosed embodiment, one tie strap 202 is on either side of each drive link 200 and one rivet 204 couples each drive link 200 and tie strap 202 combination (i.e., one drive link 200 and two tie straps 202, such that each drive link 200 is coupled to two rivets 204, and each tie strap 202 is coupled to two rivets 204). In particular, as shown, the saw chain 106 includes a first tie strap 224 coupled to a first drive link 225 by a rivet 204, a second tie strap 226 coupled to the first drive link 225 by a rivet 204, a second drive link 227 coupled to the second tie strap 226 by a rivet 204, and a third tie strap 228 coupled to the second drive link 227 by a rivet.

The saw chain 106 also includes contoured grinding segments 205 which include a first segment 206 coupled to the first tie strap 224 and a second segment 208 coupled to the third tie strap 228. The segments 205 are coupled to the tie straps 202 and positioned on a top side (e.g., away from the guide bar 104 when installed as in FIG. 1) of the tie straps 202. As shown, the segments 205 are coupled to every other tie strap 202 through a fastening process such as welding, although in other embodiments the segments 205 may be coupled by other means (e.g., sintering, adhesive, etc.), and the pattern of distribution of the segments 205 along the tie straps 202 and drive links 200 may differ depending upon the grinding conditions and needs. For example, in some embodiments consecutive tie straps 202 can have segments 205 coupled thereto. In other embodiments, every third, fourth, fifth, etc. tie strap 202 has a segment 205 coupled thereto (with other tie straps 202 lacking segments 205). In some embodiments, the segments 205 may be coupled to drive links 200.

As described in detail below, the segments 205 are constructed of a hard abrasive resistant material, one example being metal matrix composed of cobalt. Diamond particles and coated graphite particles are distributed within this 3-dimensional metal matrix, for example roughly equally throughout the matrix. During manufacturing, a top surface of the segments 205 may be formed in a manner so as to be primarily metal material, however, diamond particles below the matrix surface level must be exposed for the segments 205 to cut effectively, as the diamond particles provide friction, abrasion, scraping, grinding, etc. and are typically harder than the concrete or other material to be cut by the saw chain 106. Efficient exposure of such diamond particles via initial use of the saw chain (i.e., via self-dressing) is enabled by the segments 205.

The contoured grinding segments 205 are shown as including teeth, with each segment 205 including multiple teeth. Specifically, as shown, the first segment 206 includes a first tooth 212, a second tooth 214, and a third tooth 216 defining a top surface of the first segment 206 and arranged in series with the second tooth 214 between the first tooth 212 and the third tooth 216. Similarly, the second segment 208 is shown as including a fourth tooth 218, a fifth tooth 220, and a sixth tooth 222 defining a top surface of the second segment 208 and arranged in series with the fifth tooth 220 between the fourth tooth 218 and the sixth tooth 222. As shown, the first segment 206 contains the same number of teeth as the second segment 208, although in other embodiments segments 205 may contain different numbers of teeth than as shown (e.g., two teeth, four teeth, etc.). In the illustrated embodiment, the top surface has a surface area in a range of 0.1–0.2 square inches (in²). The segments 205 each define a first length and a first width. In the illustrated embodiment, the first length is between two and four times greater than the first width. In the illustrated embodiment, each of the teeth defines a second width substantially equal to the first width.

The segments 205 are configured to facilitate self-dressing. In particular, the segments 205 are configured so as to minimize the initial surface contact between the segments and the concrete, which increases grinding pressures and rapidly erodes the matrix, without compromising structural integrity of the segments 205. Thus, diamond points in the segments 205 are more quickly exposed for grinding as compared to other possible configurations for diamond segments of concrete grinding chains.

The segments 205 are arranged in a pattern along the saw chain 106. The second segment 208 is oriented relative to the first segment 206 such that it appears as a reflection of the first segment 206 (e.g., oriented in an opposite axial direction than the first segment 206). To elaborate, a first tie strap 224, a second tie strap 226, and a third tie strap 228 are coupled in series, with the second tie strap 226 between the first tie strap 224 and the third tie strap 228. The center of the second tie strap 226 defines a vertical line of symmetry 210 (i.e., in a plane of the saw chain 106 and orthogonal to a cutting direction of the saw chain, line of reflection, etc.). The first segment 206, which is coupled to the first tie strap 224, is oriented so as to appear as a reflection of the second segment 208 (which is coupled to the third tie strap 228), i.e., such that the saw chain 106 is symmetric across the line of symmetry 210. The pattern repeats for the entire length of the saw chain 106, so that each contoured grinding segment 205 is oriented in an opposite direction than both of its neighboring segments 205.

As shown, as a result of such symmetry, the teeth also appear as if reflected over the line of symmetry 210. For example, the first tooth 212 of the first segment 206 and the sixth tooth 222 of the second segment 208 are symmetric over the line of symmetry 210, the second tooth 214 of the first segment 206 and the fifth tooth 220 of the second segment 208 are symmetric over the line of symmetry 210, and the third tooth 216 of the first segment 206 and the fourth tooth 218 of the second segment 208 are symmetric over the line of symmetry 210.

Providing the segments 205 in such a pattern (e.g., in alternating directions) enables the saw chain 106 to be used as a bi-directional cutting chain, i.e., to cut concrete whether the cutting chain is driven in a first longitudinal direction of the chain or an opposite, second longitudinal direction of the chain. Advantageously, the saw chain 106 can be coupled to the guide bar 104 in either direction, reducing user installation error of the saw chain 106 and otherwise improving usability of the saw chain 106. In other embodiments, various other patterns of orientations of the segments 205 may be used and/or the segments 205 may be provided in the same orientation.

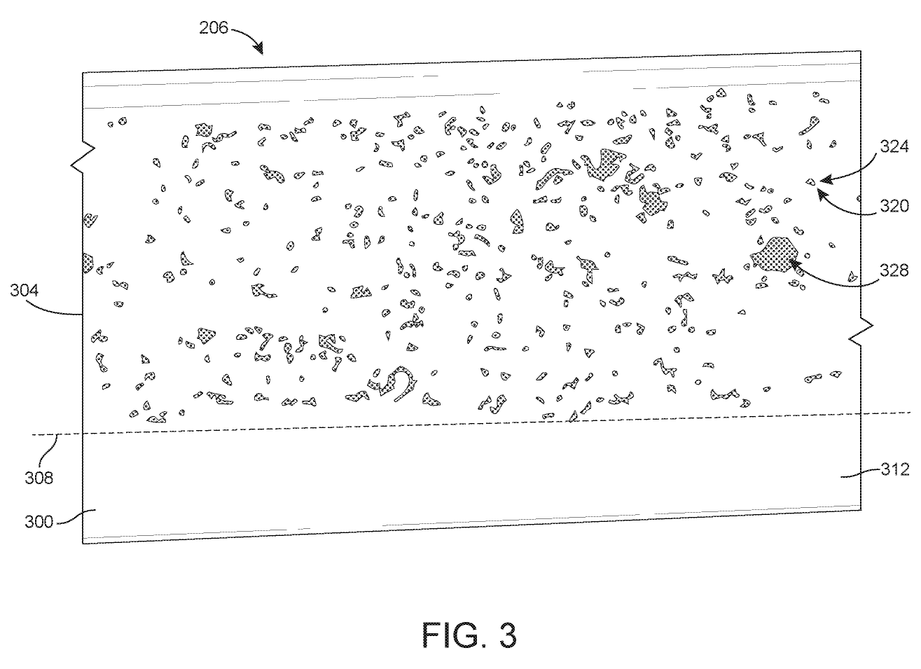

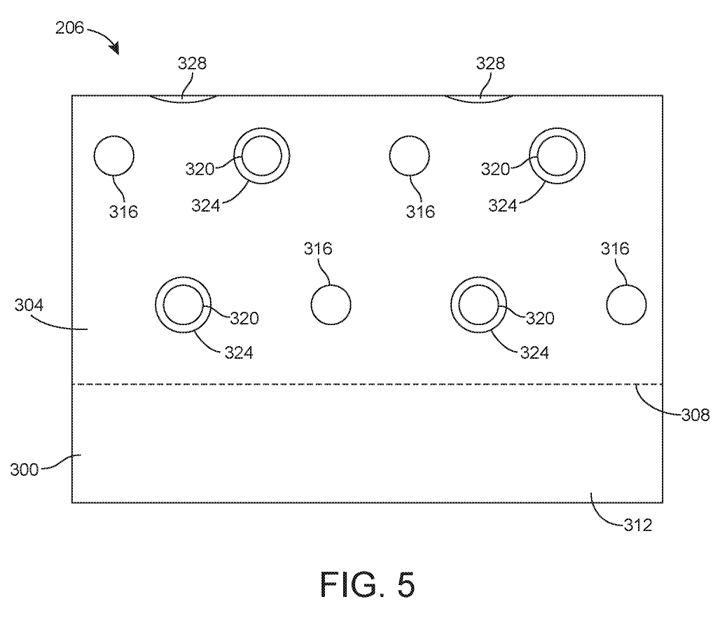

Referring now to FIGS. 3 and 5, each of the segments 205 includes a first, base section 300 and a second, grinding section 304 separated by a boundary line 308. The base section 300 is configured to couple to (e.g., for welding to) one of the tie straps 202 or drive links 200. The grinding section 304 is configured to be exposed to a work piece (e.g., a concrete pipe, reinforced concrete, etc.) and grind or cut the work piece. The grinding section 304 is offset from the tie straps 202 and the drive links 200. The grinding section 304 includes the multiple teeth. In some embodiments, the base section 300 is omitted and the entire segment 205 is the grinding section 304.

Each of the base section 300 and the grinding section 304 include a base material 312. The base material 312 includes a metal, and the metal includes at least one of Tungsten Carbide (WC), Cobalt (Co), or Fe (Iron). The grinding section 304 includes diamond particles 316. During grinding, at least a portion of the diamond particles 316 are exposed. The base material 312 is selected based on wear properties and the ability to hold and bond to the diamond particles 316. The base section 300 includes the base material 312, and does not include the diamond particles 316. The diamond particles 316 are distributed within the base material 312 of the grinding section 304, and bonded to or captured within the base material 312. The diamond particles 316 are exposed during grinding as the segments 205 wears and provide friction, abrasion, scraping, grinding, etc. In some embodiments, the combined weight of the diamond particles 316 and the base material 312 is between 92% and 99% of the total weight of the segment 205. In some embodiments, between 74% and 97% of the volume of the segment 205 is the diamond particles 316 and the base material 312. In some embodiments, between 74% and 97% of a surface area of the top surface of the segment 205 is the diamond particles 316 and the base material 312.

In the illustrated embodiment, the diamond particles 316 are evenly distributed within the base material 312 of the grinding section 304. In some embodiments, the diamond particles 316 are distributed at higher densities closer to a surface of the segments 205. For example, the segments 205 may include higher densities of the diamond particles 316 closer to a surface of the grinding section 304 configured to grind the work piece.

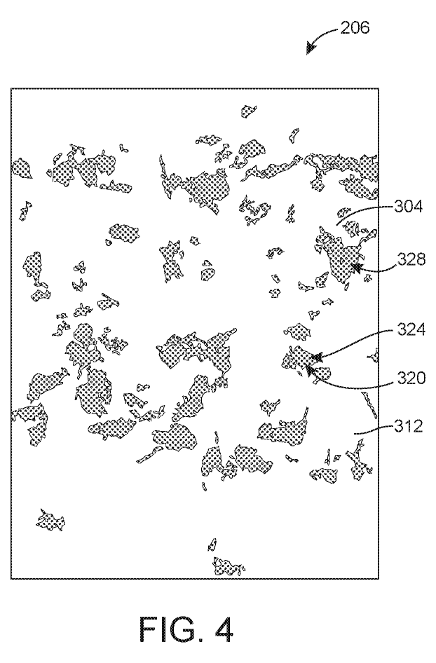

Referring now to FIGS. 3–5, the grinding section 304 also includes graphite particles 320, while the base section 300 does not include the graphite particles 320. Omission of the diamond particles 316 and the graphite particles 320 from the base section 300 facilitates welding, bonding, other coupling, etc. of the base section 300 to a tie strap or drive link (e.g., tie strap 224).

During grinding, at least a portion of the graphite particles 320 are exposed. The graphite particles 320 are distributed within the base material 312 of the grinding section 304. Adding the graphite particles 320 to the segments 205 increases the cut speed of the saw chain 106 and decreases the cutting load (e.g., the force to cut through the work piece, the resistance encountered between the segments 205 and the work piece, the heat generated during grinding, etc.). The graphite particles 320 improve the utilization rate of the diamond particles 316 by increasing the self-sharpening rate, promoting continual diamond particles 316 exposure, and enabling a graphite lubrication film to form between the segments 205 and the work piece. The graphite particles 320 act as additional abrasives. As the segments 205 wears down, the graphite particles 320 assists in grinding, exposing new diamond particles 316. As the segments 205 cuts the work piece, graphite particles 320 are deposited onto the top surface of the segment 205 and spread out to form a thin continuous film of graphite particles 320 along the top surface. The graphite lubrication film acts as a lubricant to minimize friction between the work piece and the segments 205 without limiting the abrasive effect of the diamond particles on the work piece, thereby decreasing the effort needed to cut through the work piece. The graphite particles 320 may also withstand high temperatures, enabling the graphite lubrication film to reduce hot corrosion of the diamond particles 316 in the segments 205. In the illustrated embodiment, the graphite particles 320 are evenly distributed within the base material 312. In some embodiments, the graphite particles 320 are distributed at higher densities closer to a top surface of the segments 205. For example, the segments 205 may include higher densities of the graphite particles 320 closer to the top surface of the grinding section 304 configured to contact the work piece. In some embodiments, between 3% and 26% of the volume of the segments 205 is graphite particles 320. In some embodiments, 3% to 26% of a surface area of the top surface of the segment 205 is graphite particles 320.

The grinding section 304 includes a coating 324. The coating 324 encapsulates each of the graphite particles 320 and is bonded to the base material 312. The coating 324 is metal, and includes at least one of Nickel (Ni), Cobalt (Co), Iron (Fe), Tungsten (W), Bronze, or Copper (Cu). The coating 324 is vapor deposition coated onto the graphite particles 320. In some embodiments, the coating 324 is applied to the graphite particles 320 using alternate methods (e.g., electroplating, thermal spraying, etc.). The coating 324 includes a metal different than the metal of the base material 312. For example, the coating 324 may be Nickel (Ni) and the base material 312 may be Tungsten Carbide (WC). The coating 324 assists the graphite particles 320 in bonding to the base material 312, decreasing the number of detrimental pores and cracks formed in the base material 312. The graphite particles 320 and the coating 324 also advantageously facilitate manufacturing processes, as the coating 324 behaves more favorability compared to raw graphite particles 320 in a mixture used to form the segments 205. The graphite particles 320 and the coating 324 decrease the amount of effort used by an operator while grinding with the chainsaw 100 and enable increased speeds of grinding or cutting without significantly decreasing the life of the saw chain 106. In some embodiments, the combined weight of the graphite particles 320 and the coating 324 is between 1% and 8% of a total weight of the segment 205. In some embodiments, a combined weight of the graphite particles 320 and the coating 324 is greater than 4% and less than 8% of a total weight of the segment 205. When the graphite particle 320 and coating 324 are between 1% and 8% of the total weight of the segment 205, the positive benefits previously described are achieved without any significant loss in life of the saw chain 106.

The grinding section 304 includes cavities 328 formed along the top surface of grinding section 304 and configured to contact the work piece. In some embodiments, the cavities 328 are distributed throughout the grinding section 304. The cavities 328 are configured to receive slurry generated during grinding. During grinding, a coolant such as water may be used to cool the saw chain 106 and suppress dust. The water mixes with fine particles of concrete generated from the grinding process, creating the slurry. As the slurry accumulates, the slurry fills the cavities 328 formed within the surface of the segment 205. The slurry within the cavities 328 can act as a lubricant, reducing friction between the segment 205 and the work piece, enabling smoother cuts and less wear on the saw chain 106. The number of the cavities 328 formed within the segments 205 may be increased by the addition of the graphite particles 320. For example, the size and distribution of the graphite particles 320 can create inconsistencies, creating cavities 328. The graphite particles 320 may also include different thermal expansion properties compared to the base material 312. During heating and cooling cycles used while forming the segments 205, the thermal expansion differences may cause stresses and lead to the formation of cavities 328.

As utilized herein with respect to numerical ranges, the terms “approximately,” “about,” “substantially,” and similar terms generally mean +/- 10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

What is claimed is:

1. A saw chain comprising:
a tie strap or drive link; and
a grinding segment coupled to the tie strap or the drive link, the grinding segment comprising:
a base material,
diamond particles distributed within the base material and bonded to or captured within the base material,
graphite particles distributed within the base material, and
metal coating encapsulating the graphite particles and bonded to the base material.

2. The saw chain of claim 1, wherein the metal coating includes at least one of Nickel (Ni), Cobalt (Co), Iron (Fe), Tungsten (W), Bronze, or Copper (Cu).

3. The saw chain of claim 1, wherein a combined weight of the graphite particles and the metal coating is between 1% and 8% of a total weight of the grinding segment.

4. The saw chain of claim 1, wherein a combined weight of the graphite particles and the metal coating is greater than 4% and less than 8% of a total weight of the grinding segment.

5. The saw chain of claim 1, wherein the grinding segment includes:
a first section including the base material, the diamond particles, the graphite particles, and the metal coating; and
a second section including the base material.

6. The saw chain of claim 5, wherein the second section is configured to couple to the tie strap and the first section is offset from the tie strap and configured to contact concrete the saw chain is grinding.

7. The saw chain of claim 5, wherein:
the grinding segment defines a first length and a first width, the first length between two and four times greater than the first width; and
the second section includes a plurality of teeth, each of the teeth defining a second width substantially equal to the first width.

8. The saw chain of claim 1, wherein the grinding segment defines a plurality of cavities within the base material, the cavities configured to receive slurry generated when the saw chain is used for grinding.

9. The saw chain of claim 1, wherein the grinding segment provides a top surface having a surface area in a range of 0.1–0.2 square inches (in²) and the grinding segment is configured such that when used for griding, at least of some of the graphite particles and the diamond particles are exposed at the top surface, and between 3% and 26% of a surface area of the top surface is the graphite particles.

10. The saw chain of claim 1, wherein the base material includes at least one of Tungsten Carbide (WC), Cobalt (Co), or Fe (Iron).

11. The saw chain of claim 1, wherein the base material includes a first metal and the metal coating includes a second metal, the first metal different than the second metal.

12. A grinding segment for a saw chain, the grinding segment comprising:
a base material,
diamond particles distributed within the base material and bonded to or captured within the base material,
graphite particles distributed within the base material, and
metal coating encapsulating the graphite particles and bonded to the base material.

13. The grinding segment of claim 12, wherein the grinding segment provides a top surface having a surface area in a range of 0.1–0.2 square inches (in²) and the grinding segment is configured such that when used for griding, at least of some of the graphite particles and the diamond particles are exposed at the top surface.

14. The grinding segment of claim 12, wherein the base material includes a first metal and the metal coating includes a second metal, the first metal different than the second metal.

15. The grinding segment of claim 12, including:
a first section including the base material, the diamond particles, the graphite particles, and the metal coating; and
a second section including the base material.

16. The grinding segment of claim 12, wherein a combined weight of the graphite particles and the metal coating is greater than 4% and less than 8% of a total weight of the grinding segment.

17. A chainsaw configured to grind concrete, the chainsaw comprising:
a saw chain comprising:
a tie strap or drive link; and
a grinding segment coupled to the tie strap or the drive link, the grinding segment comprising:
a base material,
diamond particles distributed within the base material and bonded to or captured within the base material,
graphite particles distributed within the base material, and
metal coating encapsulating the graphite particles and bonded to the base material.

18. The chainsaw of claim 17, wherein a combined weight of the graphite particles and the metal coating is greater than 4% and less than 8% of a total weight of the grinding segment.

19. The chainsaw of claim 17, wherein the grinding segment provides a top surface having a surface area in a range of 0.1–0.2 square inches (in²) and the grinding segment is configured such that when used for griding, at least of some of the graphite particles and the diamond particles are exposed at the top surface.

20. The chainsaw of claim 17, wherein the grinding segment includes:
a first section including the base material, the diamond particles, the graphite particles, and the metal coating; and
a second section including the base material.
